(19) United States
(12) Patent Application Publication
(10) Pub. No.: US 2022/0179428 A1
(43) Pub. Date: Jun. 9, 2022

(54) METHOD AND CONTROL SYSTEM FOR CONTROLLING AN AGRICULTURAL VEHICLE

(71) Applicant: ZF Friedrichshafen AG, Friedrichshafen (DE)

(72) Inventors: Tommy Ikonen, Friedrichshafen (DE); Muralidhar Arava, Friedrichshafen (DE)

(21) Appl. No.: 17/442,146

(22) PCT Filed: Mar. 12, 2020
(86) PCT No.: PCT/EP2020/056606

§ 371 Date: Sep. 23, 2021

(30) Foreign Application Priority Data
Mar. 27, 2019 (DE) 10 2019 204 241.4

(51) Int. Cl. G05D 1/02; A01B 69/04

(52) U.S. Cl. CPC G05D 1/0223; G05D 2201/0201; A01B 69/008

(57) ABSTRACT

A method for controlling an agricultural vehicle on an agricultural acreage includes determining a portion, lying ahead in a direction of travel of the agricultural vehicle, of a route for traveling over the agricultural acreage to a leading distance along the route. The method further includes communicating, via an end device-vehicle interface, geometrical information on the portion of the route from a mobile end device that can be carried along on the agricultural vehicle to a control device for controlling the agricultural vehicle along the route. In addition, the method includes checking, by taking into consideration the communicated geometrical information and the driving speed of the agricultural vehicle, whether traveling along the portion lying ahead has a dynamic effect, on the driving dynamics of the agricultural vehicle, that exceeds a predefined driving-dynamics threshold value. Furthermore, the method includes controlling at least one driving-dynamics component of the agricultural vehicle.

### CROSS REFERENCE TO RELATED APPLICATIONS

This application is a U.S. National Phase application under 35 U.S.C. § 371 of International Application No. PCT/EP2020/056606, filed on Mar. 12, 2020, and claims benefit to German Patent Application No. DE 10 2019 204 241.4, filed on Mar. 27, 2019. The International Application was published in Germany on Oct. 1, 2020 as WO 2020/193153 A1 under PCT Article 21(2).

### FIELD

The disclosure relates to a method for controlling an agricultural vehicle on an agricultural acreage. The disclosure also relates to a control system comprising a control device for performing steps of such a method. The disclosure additionally relates to an agricultural vehicle with such a control system.

### BACKGROUND

It is known that agricultural vehicles can travel over an agricultural acreage in an automated manner. Furthermore, assistance systems that can control the agricultural vehicle when traveling over the agricultural acreage are known in agricultural-machinery engineering.

### SUMMARY

In an embodiment, the present disclosure provides a method for controlling an agricultural vehicle on an agricultural acreage. The method includes determining a portion, lying ahead in a direction of travel of the agricultural vehicle, of a route for traveling over the agricultural acreage to a leading distance along the route, wherein the portion and the leading distance are determined as a function of a driving speed of the agricultural vehicle. The method further includes communicating, via an end device-vehicle interface, geometrical information on the portion of the route from a mobile end device that can be carried along on the agricultural vehicle to a control device for controlling the agricultural vehicle along the route. In addition, the method includes checking, by taking into consideration the communicated geometrical information and the driving speed of the agricultural vehicle, whether traveling along the portion lying ahead has a dynamic effect, on the driving dynamics of the agricultural vehicle, that exceeds a predefined driving-dynamics threshold value. The checking provides a check result. Furthermore, the method includes controlling at least one driving-dynamics component of the agricultural vehicle as a function of the check result.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows, in a plan view, an agricultural vehicle comprising a control system according to an embodiment for controlling the agricultural vehicle on an agricultural acreage; and

FIG. 2 shows a flow chart with method steps for performing a method for controlling the agricultural vehicle on the agricultural acreage in one embodiment.

### DETAILED DESCRIPTION

In one aspect, the present disclosure relates to a method for controlling an agricultural vehicle on an agricultural acreage.

Controlling the agricultural vehicle on the agricultural acreage can comprise track guidance of the agricultural vehicle. The track guidance of the agricultural vehicle can comprise or be based on traveling along a track or trajectory with the agricultural vehicle. The track can be a predetermined track. The trajectory can be a predetermined trajectory. The trajectory or track can be predetermined in coordinates, for example with GNSS coordinates. The agricultural vehicle can be guided or controlled in an automated manner along the track or trajectory. For controlling the agricultural vehicle, a lateral distance or an offset from the track or from the trajectory can be determined and corrected, for example. Alternatively, such an offset can be taken into consideration in track guidance in such a way that the track or trajectory is traveled along in an offset manner. For controlling the agricultural vehicle, an orientation deviation of the agricultural vehicle from the track or trajectory can also be determined and corrected, for example. Advantageously, the agricultural vehicle can thus be controlled automatically on the agricultural acreage. In controlling the agricultural vehicle on the agricultural acreage, it is thus not necessary for the agricultural vehicle to be actively controlled by a driver.

Controlling the agricultural vehicle on the agricultural acreage may comprise controlling the driving dynamics of the agricultural vehicle. Controlling the driving dynamics can comprise controlling the transverse dynamics of the agricultural vehicle. Alternatively or additionally, controlling the agricultural vehicle can comprise controlling the longitudinal dynamics of the agricultural vehicle. Controlling the agricultural vehicle can comprise steering of the agricultural vehicle on the agricultural acreage. In doing so, the agricultural vehicle can be controlled transversely dynamically. Controlling the agricultural vehicle can comprise accelerating or driving the agricultural vehicle on the agricultural acreage. In doing so, the agricultural vehicle can be controlled longitudinally dynamically.

The agricultural vehicle may be an agricultural or forestry machine, an agricultural or forestry device, or an agricultural or forestry commercial vehicle. The agricultural vehicle may be an agricultural towing vehicle, for example a tractor. The agricultural vehicle may also be an agricultural working vehicle, for example a harvesting machine. The agricultural acreage may be an agricultural or forestry area to be managed. For example, the agricultural acreage may comprise a field with planted or harvested crops, a meadow, or a forest.

As one step, the method comprises determining a portion, lying ahead in the direction of travel of the agricultural vehicle, of a route for traveling over the agricultural acreage. The portion of the route is determined as a function of a driving speed of the agricultural vehicle to a leading distance along the route. The distance is determined as a function of the driving speed. The route can be the track or the trajectory.

The driving speed of the agricultural vehicle may be a current driving speed of the agricultural vehicle. Alternatively, the driving speed of the agricultural vehicle may be a future driving speed when the portion of the route lying ahead is traveled along. The future driving speed can be a constant or changing driving speed when the portion of the route is traveled along.

The leading distance along the route can be defined as a function of the driving speed of the agricultural vehicle. The leading distance can be defined proportionally to the driving speed of the agricultural vehicle. The greater the driving speed of the agricultural vehicle, the greater the leading distance along the route. The smaller the driving speed of the agricultural vehicle, the smaller the leading distance along the route.

As a further step, the method comprises communicating geometrical information on the specific portion of the route to a control device for controlling the agricultural vehicle along the route. The geometrical information is communicated by a mobile end device that can be carried along on the agricultural vehicle to the control device via an end device-vehicle interface. The geometrical information can be requested by the control device. Alternatively, the geometrical information can be transmitted or sent as a control command by the mobile end device or by an operator of the mobile end device to the control device in order to control the agricultural vehicle.

Communicating geometrical information on the specific portion of the route may comprise at least one of outputting, transmitting, and reading of geometrical information on the specific portion of the route. Communicating may comprise outputting geometrical information by the mobile end device via an output interface of the mobile end device. Alternatively or additionally, communicating geometrical information may comprise transmitting geometrical information from the mobile end device via the end device-vehicle interface to the control device. Alternatively or additionally, communicating geometrical information may comprise reading geometrical information by the control device via a reading interface of the control device. The geometrical information may comprise at least one point with respect to the specific portion of the route. The at least one point may lie on the route along the specific portion. Alternatively or additionally, the geometrical information may comprise at least one geometrical element with respect to the specific portion of the route.

The geometrical information on the specific portion of the route may be waypoint information along the route, which may be arranged at least partially along the specific portion of the route. The waypoint information may comprise a single or a plurality of waypoints. The plurality of waypoints may comprise at least two waypoints. The waypoints may be equidistantly arranged waypoints. Alternatively or additionally, the waypoints may be waypoints with a curvature-based point spacing. For example, waypoints may be arranged in a circular arc-shaped portion of the route with a point spacing that is smaller than a point spacing of waypoints arranged in a straight-line portion of the route. The waypoint information may be present in a coordinate system. The coordinate system may be a vehicle-related or an acreage-related coordinate system.

The geometrical information may be a geometrical abstraction of the specific portion of the route. The geometric abstraction of the portion of the route may be a selection of waypoint information along the route. The geometric abstraction of the portion of the route lying ahead may furthermore be a geometric simplification or parameterization of the waypoint information. Alternatively or additionally, the geometric abstraction of the portion of the route may be a mathematical or geometrical function or curve for approximating the waypoint information or the portion of the route. For this purpose, the waypoint information can comprise mathematical support points. Alternatively or additionally, the geometrical abstraction of the portion of the route may be a tracking element or a tracking parameter, each of which may be based on the waypoint information.

The mobile end device may, for example, be a mobile phone, a smartphone, or a tablet. The mobile end device may be a mobile control unit for controlling the agricultural vehicle. Furthermore, the mobile end device may be an electronic entertainment device or a so-called “insecure end device.” The mobile end device may be a device that is segregated with respect to the agricultural vehicle, i.e., a device that is not integrated into the agricultural vehicle. The portable mobile end device may thus be a mobile end device riding along on the agricultural vehicle, but a mobile end device that is not permanently or fixedly connected to the agricultural vehicle.

The end device-vehicle interface may be a wireless or a wired (end device-vehicle) interface. The end device-vehicle interface may be a radio-based or a cable-based interface. If the end device-vehicle interface is a wireless or a radio-based interface, it may be a mobile radio interface, a WLAN interface, a Bluetooth interface, or an IrDA interface. If the end device-vehicle interface is a wired, line- or cable-based interface, it may be a USB interface or a serial interface. The end device-vehicle interface may furthermore comprise an adapter for receiving the mobile end device on the agricultural vehicle. The end device-vehicle interface may furthermore comprise a plug by means of which the mobile end device can be connected to the control device. By means of the adapter or the plug, the mobile end device can be temporarily connected and carried along on the agricultural vehicle.

In addition to the end device-vehicle interface, which may be configured as a communications interface of the mobile end device, the mobile end device may comprise at least one further interface. The mobile end device may comprise a user interface as a further interface. The user interface may be an LCD interface, a touch display, a keyboard, or an audio interface. Via the user interface, an operator of the agricultural vehicle can send a corresponding communication command or a corresponding control command to the control device of the agricultural vehicle. The communication command can be used to initiate the communication of the geometrical information. The operator may be a driver of the agricultural vehicle. As a further interface, the mobile end device may comprise a memory interface for reading the route for traveling over the agricultural acreage. A route that has been planned on a device that cannot be carried along on the agricultural vehicle can be transferred to a memory unit of the mobile end device via the memory interface.

The method has a checking step as a further step. The checking step checks whether traveling along the portion lying ahead, taking into consideration the communicated geometrical information and the driving speed of the agricultural vehicle, has a dynamic effect that exceeds a predefined driving-dynamics threshold value on the driving dynamics of the agricultural vehicle.

The driving dynamics of the agricultural vehicle can comprise at least one of a transverse dynamics of the agricultural vehicle and a longitudinal dynamics of the agricultural vehicle. The dynamic effect may thus comprise at least one of a transversely dynamic effect and a longitudinally dynamic effect. When traveling along the portion lying ahead, at least one of a force, a torque, a speed, and an acceleration can act as a dynamic influence on the agricultural vehicle. The force acting on the vehicle may comprise at least one of a transverse force and a longitudinal force. The torque may, for example, be a tilting moment of the agricultural vehicle, which may occur along a curved portion of the route during travel. The predefined driving-dynamics threshold value may be a threshold value corresponding to the described dynamic effects. For example, the threshold value may be a force threshold value, a torque threshold value, a speed threshold value, or an acceleration threshold value.

The checking step can have various check results. As a check result, it can be established that traveling along the portion lying ahead, taking into consideration the communicated geometrical information and the driving speed of the agricultural vehicle, has a dynamic effect that exceeds the predefined driving-dynamics threshold value on the driving dynamics of the agricultural vehicle. As a further check result, it can be established that traveling along the portion lying ahead, taking into consideration the communicated geometrical information and the driving speed of the agricultural vehicle, has a dynamic effect that does not exceed a predefined driving-dynamics threshold value on the driving dynamics of the agricultural vehicle. Yet a further check result of the checking step may be that traveling along the portion lying ahead, taking into consideration the communicated geometrical information and the driving speed of the vehicle, does not have any effect that is relevant to one of the described dynamic effects on the driving dynamics of the agricultural vehicle.

As a further step, the method comprises controlling at least one driving-dynamics component of the agricultural vehicle as a function of a check result of the step of checking. The check result may be one of the described check results.

The at least one driving-dynamics component may comprise at least one of a transverse-dynamics component and a longitudinal-dynamics component of the agricultural vehicle. The driving-dynamics component may furthermore comprise a component of a drive train of the agricultural vehicle. For example, the driving-dynamics component may be a steering system of the agricultural vehicle or a component thereof or a drive of the agricultural vehicle or a component thereof. The driving-dynamics component may also be a further control of the agricultural vehicle, for example a steering control or a drive control.

Within the scope of the present disclosure, a driving-dynamics safety risk can be checked, taking into consideration geometrical information on a route to be traveled along and a driving speed of the agricultural vehicle along the route to be traveled along. If the dynamic effect on the driving dynamics of the agricultural vehicle exceeds a predefined driving-dynamics safety threshold value, traveling along the portion lying ahead of the route to be traveled along may comprise a safety risk. Such a safety risk can be advantageously reduced according to the present disclosure.

The checking step can comprise checking whether a driving-dynamics safety risk is present for the agricultural vehicle or its driver when driving the portion lying ahead. The checking step may furthermore comprise plausibility checking of the lying-ahead portion to be traveled along. It is possible to check whether a geometry of the portion of the route to be traveled along can be traveled along at the driving speed of the agricultural vehicle without the travel causing damage to the vehicle or to the driver. The present disclosure therefore advantageously makes it possible to preventively avoid unsafe driving-dynamics behavior of the agricultural vehicle when traveling along a route. An automated operation of the agricultural vehicle on the agricultural acreage can thus be carried out more safely.

At least one of the steps of the method can be carried out in an automated manner. The agricultural vehicle can thus be controlled at least partially in an automated manner. Alternatively or additionally, at least one of the steps of the method can be carried out continuously while controlling the agricultural vehicle on the agricultural acreage. The steps of the method may furthermore be carried out in a loop for continuously carrying out the method. A driver of the agricultural vehicle can monitor, check, or confirm at least one of the steps.

In one embodiment of the method, in the step of determining, the portion of the route lying ahead is also determined from a further leading distance from the agricultural vehicle along the route. The portion lying ahead can thus be determined between the two leading distances. The portion lying ahead can thus be determined from the further leading distance to the leading distance. The portion of the route lying ahead can be determined along the route in the direction of travel of the agricultural vehicle at a distance therefrom. The determined portion lying ahead may define a portion to be driven by the agricultural vehicle in the future. The determined portion lying ahead may span a forecast region along the route wherein the further leading distance may define a forecast horizon and the leading distance may define a forecast limit.

A further embodiment of the method comprises communicating, as a further step, a driving speed curve along the determined portion of the route. As a further step, the method may comprise determining the driving speed curve in relation to the portion of the route lying ahead. The driving speed curve can be determined and communicated as a function of the driving speed. According to this embodiment, the step of checking can also be performed taking into consideration the communicated driving speed curve. It can be checked whether traveling along the portion lying ahead, taking into consideration the communicated geometrical information and the communicated driving speed curve, has the dynamic effect that exceeds the predefined driving-dynamics threshold value on the driving dynamics of the agricultural vehicle.

The dynamic effect may be derived based on the geometrical information and the driving speed or the driving speed curve. One of the described dynamic effects can thus be calculated based on the geometrical information and the driving speed or the driving speed curve. Within the framework of this embodiment, the geometrical information, together with metadata, for example the driving speed curve, can thus be communicated from the mobile end device via the end device-vehicle interface to the control device of the agricultural vehicle.

A further embodiment of the method comprises, as a further step, calculating, based on the communicated geometrical information, curvature information regarding the portion of the route lying ahead in the direction of travel of the agricultural vehicle. The step of checking may comprise checking whether traveling along the portion lying ahead, taking into consideration the calculated curvature information and a driving speed of the agricultural vehicle along the portion lying ahead, has the dynamic effect. The curvature information may comprise a curvature or a curvature course or a radius of a portion of the route to be traveled along, for example of a circular arc. The checking step can thus also be performed taking into consideration the calculated curvature information and the communicated driving speed curve.

The portion of the route lying ahead may be a curved portion of the route. Advantageously, a curved portion of the route lying ahead can be checked, taking into consideration the driving speed or the driving speed curve, as to whether a steering angle, resulting from the curvature information, for traveling along the route has the dynamic effect. The checked steering angle for driving the portion lying ahead can be used to control the steering system of the agricultural vehicle if the dynamic effect resulting from the steering angle does not exceed the predefined driving-dynamics threshold value. The method therefore controls steering angles that advantageously result in safe operation of the agricultural vehicle. Alternatively, the driving speed of the agricultural vehicle for driving the portion lying ahead can also be reduced in order to reduce the dynamic effect so that the predefined driving-dynamics threshold value is not exceeded.

In a further embodiment of the method, the step of checking comprises a checking whether an inertia-induced force that exceeds a predefined force acts on the agricultural vehicle when traveling along the portion lying ahead. The inertia-induced force may be a centrifugal force or a centripetal force. The predefined force may be a corresponding predefined force threshold value. It can thus be advantageously checked whether a tilting moment that can result in a tilting of the agricultural vehicle acts on the agricultural vehicle when traveling along a curved portion lying ahead. With the method, an agricultural vehicle can thus be safely controlled, for example along a headland, without the agricultural vehicle losing traction in the headland.

A further embodiment of the method comprises, as a further step, detecting an environment of the agricultural vehicle in order to detect an obstacle along the portion of the route lying ahead in the direction of travel of the agricultural vehicle with an environment detection sensor system. The environment detection sensor system may comprise at least one environment detection sensor. The at least one environment detection sensor may comprise at least one of at least one laser scanner, at least one radar device, and at least one camera. A detected obstacle may, for example, be recognized in an automated manner in measured data from at least one sensor of the environment detection sensor system based on methods of pattern recognition or image processing.

According to this embodiment, a further checking step can be performed when an obstacle has been detected or recognized. In the further checking step, it can be checked whether traveling along the portion lying ahead, taking into consideration the detected obstacle, comprises a risk of collision between the agricultural vehicle and the detected obstacle. If the obstacle is located along the route to be traveled along or along the portion lying ahead, or if the obstacle moves on the route or onto the portion lying ahead, the risk of collision may exist.

If travel comprises a risk of collision as a check result, the steering system, drive, or brake of the vehicle can, for example, be controlled as a driving-dynamics component. The agricultural vehicle can be controlled advantageously in such a way that the obstacle is driven around by the agricultural vehicle or that the agricultural vehicle brakes before it. With the further checking step, the method can thus comprise a two-stage check for a risk of collision and a driving-dynamics safety risk. An automated operation of the agricultural vehicle on the agricultural acreage can thus advantageously be more efficient and safer.

In a further embodiment of the method, the step of further checking comprises checking whether there is sufficient reaction time for braking the vehicle when traveling along the portion lying ahead. The reaction time may be a reaction time for performing emergency braking before a detected obstacle. The agricultural vehicle can be braked in an automated manner. Alternatively, the brake or control of the agricultural vehicle can also be transferred to an operator for operator-guided braking. Damage to the vehicle or to the obstacle can thus advantageously be avoided. The obstacle can be a structural unit, a terrain elevation or terrain depression on the agricultural acreage, or an animal. Even if communication via the end device-vehicle interface is aborted, the agricultural vehicle can still be braked before an obstacle in a timely manner as a result of the further checking step.

A further embodiment of the method comprises, as a further step, buffering the communicated geometrical information in a memory unit of the control device. A communicated driving speed curve can also be buffered in this way. Before driving on the agricultural acreage, the vehicle can be at a standstill until geometrical information regarding the route up to the specific portion of the route has been communicated and buffered. The buffered geometrical information may be used to control the at least one driving-dynamics component if it has been checked according to at least one of the described checking steps. The method can thus advantageously already be performed before driving on the agricultural acreage and also during driving on the agricultural acreage.

In a further aspect, the present disclosure relates to a control system comprising a control device and a mobile end device for performing the steps of the method according to the preceding aspect. The control device and the mobile end device are the described control device and the described mobile end device. In addition, the control system may comprise any further component described in relation to the preceding aspect for performing the method according to the preceding aspect.

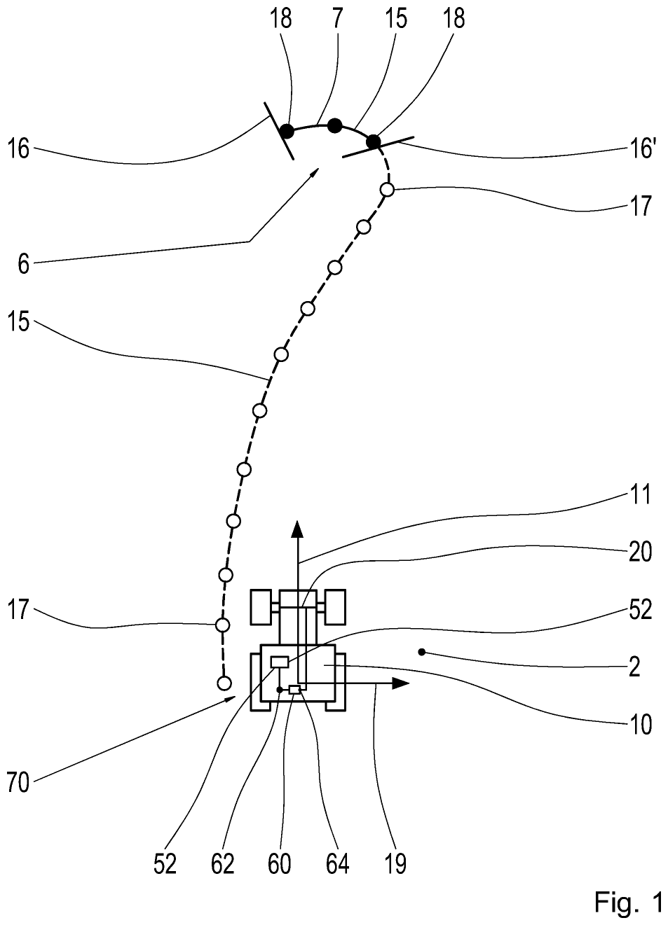

FIG. 1 shows an agricultural vehicle 10 on an agricultural acreage 2. The agricultural vehicle 10 travels along the agricultural acreage 2 along a route 15, wherein the agricultural vehicle 10 travels at a lateral offset from the route 15 in the embodiment shown.

The agricultural vehicle 10 comprises a control system 70. The control system 70 comprises a control device 60 and a mobile end device 52, which are connected via an end device-vehicle interface 62. The agricultural vehicle 10 also comprises a vehicle coordinate system 19, the ordinate of which defines the direction of travel 11 of the agricultural vehicle 10. The control device 60 is also connected via an output interface 64 to a steering system 20, a front axle steering system in the embodiment shown, in order to control it for driving over the agricultural acreage 2 with the agricultural vehicle 10. A corresponding control command is output via the output interface 64.

The route 15 comprises waypoints 17 buffered in a memory unit of the control system 70 not shown in FIG. 1, and waypoints 18 currently being read at the control device 60 via the end device-vehicle interface 62 from the mobile end device 52. The buffered waypoints 17 are stored along the route 15 up to a first leading distance 16′. The read waypoints 18 were read along the route 15 from the first leading distance 16′ to a second leading distance 16 along the route 15. Between the two leading distances 16′, 16, a portion 6 lying ahead along the route 15 is defined, wherein a curvature 7 of the portion 6 lying ahead was calculated as geometrical information on the portion 6 lying ahead based on the read waypoints 18 with a computing unit of the control device 60 not shown in FIG. 1.

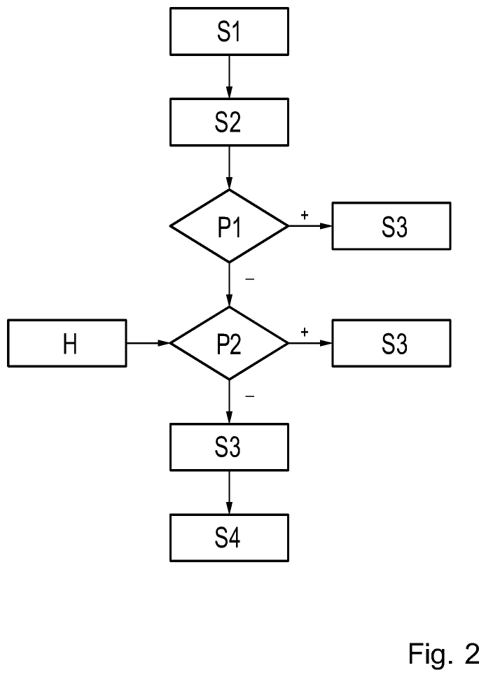

FIG. 2 shows a flow chart with method steps S1 to S5. The flow chart also comprises two checking steps P1, P2. The flow chart moreover comprises a detection step H.

In a first step S1, a portion determination takes place. In the first step S1, the portion 6 of the route 15 lying ahead in the direction of travel 11 of the agricultural vehicle 10 for traveling over the agricultural acreage 2 from the first leading distance 16′ to the second leading distance 16 along the route 15 is determined as a function of the current driving speed of the agricultural vehicle 10.

In a second step S2, waypoints 18 along the portion 6 of the route 15 are transmitted from the mobile end device 52 on the agricultural vehicle 10 via the end device-vehicle interface 62 to the control device 60 for controlling the steering system 20 of the agricultural vehicle 10. For this purpose, the control device 60 controls a steering control of the steering system 12 not shown in FIG. 1.

After the first two steps S1, S2, a first checking step P1 is performed. In the first checking step P1, it is checked whether traveling with the agricultural vehicle 10 along the portion 6 with its curvature 7, which was calculated based on the waypoints 18 of the portion 6, and the current driving speed of the agricultural vehicle 10 results in a tilting moment of the agricultural vehicle 10, in which the agricultural vehicle 10 loses traction. In doing so, it is checked whether the tilting moment exceeds a tilting moment threshold value predefined as a function of the curvature 7 and the speed of the agricultural vehicle 10.

If such a tilting moment that exceeds the predefined tilting moment threshold value is present, a driving-dynamics control of the agricultural vehicle 10 takes place in a third step S3. In one embodiment, a brake, not shown in FIG. 1, of the agricultural vehicle 10 is controlled in order to brake the agricultural vehicle 10 and reduce its driving speed for driving the portion 6 lying ahead along the route 15.

On the other hand, if the tilting moment does not exceed the predefined tilting moment threshold value, or if the driving speed is reduced, a second checking step P2 is performed.

Before the second checking step P2 is performed, an environment detection H takes place. The environment of the agricultural vehicle 10 is detected in the detection step H. If an obstacle not shown in FIG. 1 is located in the environment of the agricultural vehicle 10 on the agricultural acreage 2, the obstacle is detected. In the second checking step P2, it is checked whether the detected obstacle poses a risk of collision with the agricultural vehicle 10 when traveling along the route 15. If such a risk of collision exists, the brake of the agricultural vehicle 10 not shown in FIG. 1 is controlled in the third step S3 of the driving-dynamics control in order to brake the agricultural vehicle 10 before the detected obstacle.

If no obstacle is detected in the detection step H or if the check result of the second checking step P2 is that no risk of collision exists, the third step S3 of the driving-dynamics control is performed. The steering system 20 of the agricultural vehicle 10 and the drive of the agricultural vehicle 10 not shown in FIG. 1 are controlled in a fourth step S4 for traveling along the portion 6 lying ahead. When the portion 6 lying ahead is traveled along in the fourth step S4, the agricultural vehicle 10 is steered and driven in such a way that a resulting tilting moment when driving the portion 6 lying ahead does not cause the agricultural vehicle 10 to tip over.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE CHARACTERS

2 Agricultural acreage
6 Portion lying ahead
7 Curvature
10 Agricultural vehicle
11 Direction of travel
15 Route
16, 16′ Leading distance
17 Buffered waypoint
18 Read waypoint
19 Vehicle coordinate system
20 Steering system
52 Mobile end device
60 Control device
62 End device-vehicle interface
64 Output interface
70 Control system
H Environment detection
P1 Driving dynamics check
P2 Collision check
S1 Portion determination
S2 Information communication
S3 Driving-dynamics control
S4 Travel

1. A method for controlling an agricultural vehicle on an agricultural acreage, the method comprising:
determining a portion, lying ahead in a direction of travel of the agricultural vehicle, of a route for traveling over the agricultural acreage to a leading distance along the route, wherein the portion and the leading distance are determined as a function of a driving speed of the agricultural vehicle,
communicating, via an end device-vehicle interface, geometrical information on the portion of the route from a mobile end device that can be carried along on the agricultural vehicle to a control device for controlling the agricultural vehicle along the route,
checking, by taking into consideration the communicated geometrical information and the driving speed of the agricultural vehicle, whether traveling along the portion lying ahead has a dynamic effect, on the driving dynamics of the agricultural vehicle, that exceeds a predefined driving-dynamics threshold value, wherein the checking provides a check result, and
controlling at least one driving-dynamics component of the agricultural vehicle as a function of the check result.

2. The method according to claim 1, wherein, the portion of the route lying ahead is also determined from a further leading distance from the agricultural vehicle along the route.

3. The method according to claim 1, further comprising communicating a driving speed curve along the determined portion of the route, wherein the checking whether traveling along the portion lying ahead is also performed by taking into consideration the communicated driving speed curve.

4. The method according to claim 1, further comprising calculating curvature information on the portion of the route lying ahead based on the communicated geometrical information, wherein the checking comprises checking whether traveling along the portion lying ahead has the dynamic effect, taking into consideration the calculated curvature information and a driving speed of the agricultural vehicle along the portion lying ahead.

5. The method according to claim 1, wherein the checking comprises checking whether an inertia-induced force that exceeds a predefined force acts on the agricultural vehicle when traveling along the portion lying ahead.

6. The method according to claim 1, further comprising detecting an environment of the agricultural vehicle in order to detect an obstacle along the portion of the route lying ahead using an environment detection sensor system, and further checking when an obstacle has been detected, whether traveling along the portion lying ahead, taking into consideration the detected obstacle, comprises a risk of collision between the agricultural vehicle and the detected obstacle.

7. The method according to claim 6, wherein the further checking comprises checking whether there is sufficient reaction time for braking the agricultural vehicle when traveling along the portion lying ahead.

8. The method according to claim 1, further comprising buffering the communicated geometrical information in a memory of the control device.

9. A control system comprising:
a control device and a mobile end device configured to perform the method according to claim 1.

10. An agricultural vehicle comprising a control system according to claim 9.
